(19) United States
(12) Patent Application Publication
(10) Pub. No.: US 2025/0059308 A1
(43) Pub. Date: Feb. 20, 2025

(54) METHOD FOR THE EMULSION POLYMERIZATION OF FLUOROMONOMER

(71) Applicant: SOLVAY SPECIALTY POLYMERS ITALY S.P.A., Bollate (Milano) (IT)

(72) Inventors: Daniela Bertani, Milano (mi) (IT); David James Wilson, LA POMAREDE (FR); Pierre-Emmanuel Dufils, Paris (FR)

(73) Assignee: SOLVAY SPECIALTY POLYMERS ITALY S.P.A., Bollate (Milano) (IT)

(21) Appl. No.: 18/721,117

(22) PCT Filed: Dec. 12, 2022
(86) PCT No.: PCT/EP2022/085277

§ 371 Date: Jun. 17, 2024

(30) Foreign Application Priority Data
Dec. 17, 2021 (EP) 21306824.0

(51) Int. Cl. C08F 214/22; C08F 2/22; C08F 2/38; C08F 220/14

(52) U.S. Cl. CPC C08F 214/22; C08F 2/22; C08F 2/38; C08F 220/14; C08F 2438/03; C08F 2800/10

(57) ABSTRACT

The invention pertains to a process for polymerizing fluoromonomers in the presence of a certain amphiphilic reversible addition fragmentation chain transfer (RAFT) agent.

### CROSS-REFERENCE TO RELATED APPLICATIONS

This application claims priority from European patent application Nr 21306824.0, filed on 17 Dec. 2021, the whole content of this application being incorporated herein by reference for all purposes.

### TECHNICAL FIELD

The invention relates to a method for polymerizing fluoromonomers in the presence of a certain amphiphilic reversible addition fragmentation chain transfer (RAFT) agent.

### BACKGROUND ART

Vinylidene fluoride polymers, including thermoplastic and elastomeric polymers, are known for being manufactured through radical polymerization technologies.

Over the past decade, various controlled/living polymerization (CLP) techniques have been proven to be effective in causing polymerization-induced self-assembly, by extending hydrophilic living chains with a hydrophobic segment, so as to generate block copolymers which self-assemble to achieve controlled morphologies in situ. Among CLP techniques, reversible addition fragmentation chain transfer (RAFT) and macromolecular design via inter-exchange of xanthate (MADIX) techniques have been widely explored, see for instance PERRIER, S., et al. Macromolecular design via Reversible Addition-Fragmentation Chain Transfer (RAFT)/Xanthates (MADIX) polymerization. J. Polym. Sci.: Part A: Polym. Chem. 2005, vol. 43, p. 5347-5393.

The expression “RAFT agent”, which for the avoidance of doubt is intended to mean “RAFT or MADIX agent”, is used in the present specification to refer to a class of compounds containing the functional group —X(═S)—S—, wherein X is phosphorus or carbon, preferably carbon. MADIX agents are more specifically characterised by the presence of the xanthate functional group, namely —O—C(═S)—S—. RAFT agents are capable to act as a reversible chain transfer agent in free-radical polymerizations, thereby inducing reversible-addition fragmentation transfer reactions to create an equilibrium between propagating radicals (i.e. the growing polymer chain) and so-called dormant species (containing the chain transfer agent fragment) that can become active again. The generally accepted mechanism of RAFT controlled radical polymerization is shown in Scheme I.

U.S. Pat. No. 7,012,114 (RHODIA CHIMIE) discloses a free-radical emulsion polymerization of an at least one ethylenically unsaturated monomer in the presence of a free-radical initiator and of a polymer comprising at its end a group selected from dithioesters, thioether-thiones, diothiocarbamates and xanthates. The said polymer may have units derived from hydrophilic monomers, and units derived from hydrophobic monomers, and may be a monoblock, diblock or triblock polymer. The ethylenically unsaturated monomer may be of formula CX_{d}X′_{d}(═CV_{d}—CV′_{d})ₜ═CH₂ wherein: X_{d} and X′_{d}, which are identical or different, represent: H, an alkyl group or a halogen, V_{d} and V′_{d}, which are identical or different, represent H, a halogen or a group R, OR, OCOR, NHCOH, OH, NH₂, NHR, N(R)₂, (R)₂N⁺O⁻, NHCOR, CO₂H, CO₂R, CN, CONH₂, CONHR or CONR₂, wherein R, which is identical or different, is selected from the group consisting of alkyl, aryl, aralkyl, alkaryl, alkene and organosilyl groups, optionally perfluorinated and optionally substituted with one or more carboxyl, epoxy, hydroxyl, alkoxy, amino, halogen or sulphonic groups, and t is 0 or 1. No mention is made of the possibility of polymerizing vinylidene fluoride in the presence of said polymer having dithioester, thioether-thione, or diothiocarbamate functionality.

WO 2006/037171 (University of Sydney) discloses a method of polymerising certain monomers in the presence of a RAFT agent and of certain particulate materials; the said RAFT agent may be of formula:

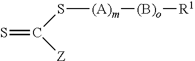

where each A and B is independently a polymerised residue of an ethylenically unsaturated monomer such that -(A)ₘ- provides hydrophobic properties and -(B)₀- provides hydrophilic properties. According to this document, a wide range of ethylenically unsaturated monomers may be polymerized in accordance with this method, suitable monomers being those which can be polymerised by a free radical process, without nonetheless vinylidene fluoride being mentioned.

WO 2015/173193 A (SOLVAY SPECIALTY POLYMERS ITALY S.p.A.) 19 Nov. 2015 relates to a method for the emulsion polymerization of fluoromonomers under the control of a RAFT/MADIX agent.

### SUMMARY OF INVENTION

Thus a first objective of the present invention is to provide a method for making a latex of a fluoropolymer, in the presence of an amphiphilic polymeric RAFT agent of formula (I) [agent (R)]:

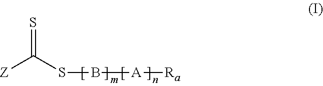

as below detailed.

The Applicant has surprisingly found that thanks to its self-assembled polymeric micelle structure, in the form of an outer hydrophilic shell and an inner hydrophobic core, agent (R) is acting as an effective amphiphilic particulate emulsifier for fluoro monomer polymerization, effective in assisting polymerization of fluoromonomers, in particular vinylidene fluoride (VDF), up to high solid contents, stabilizing resulting latex with no necessary addition of surface agents.

### DESCRIPTION OF INVENTION

According to a first object of the present invention there is provided a method for the emulsion polymerization of at least one fluoromonomer, said method comprising:
polymerizing a monomer mixture [mixture (M)] comprising at least one fluoromonomer and optionally at least one additional monomer, in an aqueous medium comprising an amphiphilic polymeric RAFT agent of formula (I):

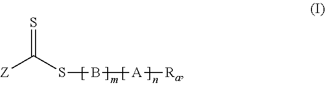

where:
Rₐ is an organic group optionally substituted with one or more hydrophilic groups;
-[A]ₙ- represents a sequence of repeating units -A- derived from at least one ethylenically unsaturated monomer having hydrophilic character [monomer (A)], whereas n is an integer from 2 to 300, preferably from 2 to 250, even from 3 to 200, more preferably from 3 to 150 and even more preferably from 3 to 120;
-[B]ₘ- represents a sequence of recurring units -B- derived from at least one ethylenically unsaturated monomer having hydrophobic character [monomer (B)], whereas m is an integer from 2 to 300, preferably from 2 to 250, even from 3 to 200, more preferably from 3 to 150 and even more preferably from 3 to 120; and
Z is selected from the group consisting of optionally substituted alkoxy, optionally substituted aryloxy, optionally substituted heterocyclyl, optionally substituted alkylthio, optionally substituted arylalkylthio, dialkoxy- or diaryloxy-phosphinyl [—P(═O)(OR⁴)₂], dialkyl- or diaryl-phosphinyl [—P(═O)R⁴₂], where R⁴ is selected from the group consisting of optionally substituted C₁-C₁₈ alkyl, optionally substituted C₂-C₁₈ alkenyl, optionally substituted aryl, optionally substituted heterocyclyl, optionally substituted aralkyl, optionally substituted alkaryl, optionally substituted acylamino, optionally substituted acylimino, optionally substituted amino, a polymer chain formed by any mechanism; and wherein Z may be additionally selected from the group consisting of optionally substituted alkyl, preferably optionally substituted C₁-C₂₀ alkyl, optionally substituted aryl, and optionally substituted arylalkyl. Optional substituents for R⁴ and Z groups include epoxy, hydroxy, alkoxy, acyl, acyloxy, carboxy (and its salts), sulfonic acid (and its salts), alkoxy- or aryloxy-carbonyl, isocyanato, cyano, silyl, halo, and dialkylamino
[agent (R)]; and
terminating the polymerization and recovering a latex of fluoropolymer [polymer (F)].

Generally Z is selected, without limitation, from the group consisting of: —R⁵, —OR⁵, —SR⁵, where R⁵ is an optionally substituted C₁-C₂₀ alkyl; —NR⁵R⁶ wherein R⁵ is as defined and R⁶ is selected from optionally substituted C₁-C₂₀ and alkyl optionally substituted aryl; and

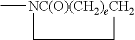

wherein e is an integer from 2 to 4.

Preferably Z is selected from the group consisting of —OR⁵, —SR⁵, where R⁵ is an optionally substituted C₁-C₂₀ alkyl; —NR⁵R⁶ wherein R⁵ is as defined and R⁶ is selected from optionally substituted C₁-C₂₀ and alkyl optionally substituted aryl; and

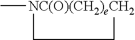

wherein e is an integer from 2 to 4.

More preferably, Z is selected from the group consisting of —SR⁵, where R⁵ is an optionally substituted C₁-C₂₀ alkyl; —NR⁵R⁶ wherein R⁵ is as defined and R⁶ is selected from optionally substituted C₁-C₂₀ and alkyl optionally substituted aryl; and

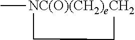

wherein e is an integer from 2 to 4.

Even more preferably, Z is selected, without limitation, from the group consisting of —SCH₂(C₆H₅), —S(CH₂)ᵤCO₂H wherein u is an integer from 2 to 11, —OC_{z}H_{2z+1}, —SC_{z}H_{2z+1}, wherein z is an integer from 1 to 12, preferably from 2 to 12, such as, without limitation, 2, 3, 4, 6, 8, 10, 12, —SCH₂CH₂OH, —OCH₂CF₃, —N(C₆H₅)(CH₃).

In formula (I), Rₐ may be selected from C₁-C₆ alkyl, C₁-C₆ alkoxy, aryl or heteroaryl, each of which may be substituted with one or more hydrophilic groups selected from —CO₂H, —CO₂R, —CN, —SO₃H, —OSO₃H, —SOR, —SO₂R, —OP(OH)₂, —P(OH)₂, —PO(OH)₂, —OH, —OR, —(OCH₂—CHR⁰)_{w}—OH, —(OCH₂—CHR⁰)_{w}—OR, —CONH₂, CONHR¹, CONR¹R², —NR¹R², —NR¹R²R³, where R is selected from C₁-C₆ alkyl, R⁰ is selected from hydrogen or R, w is an integer from 1 to 10, R¹, R² and R³ are independently selected from C₁-C₆ alkyl and aryl which are optionally substituted with one or more hydrophilic substituent selected from —CO₂H, —SO₃H, —OSO₃H, —OH, —(OCH₂CHR⁰)_{w}—OH, —CONH₂, —SOR and SO₂R, and salts thereof, wherein R, R⁰ and w are as defined above.

Preferably Rₐ is selected, without limitation, from the group consisting of: —C(CH₃)₂—CH₂CH₂—CO₂H, —CH(CH₃)CO₂H, —CH(CO₂H)CH₂CO₂H, —C(CH₃)₂CO₂H, —CH₂(C₆H₅), —C(CN)(CH₃)CO₂H, —C(CN)(CH₃)CH₂CH₂CO₂H.

As used herein, the terms “aryl” and “heteroaryl” refer to any substituent which includes or consists of one or more aromatic or heteroaromatic ring respectively, and which is attached via a ring atom. The rings may be mono or polycyclic ring systems, although mono or bicyclic 5 or 6 membered rings are preferred. The term “alkyl”, used either alone or in combination, as in “alkenyloxyalkyl”, “alkylthio”, “alkylamino” and “dialkylamino” denotes straight chain, branched or cyclic alkyl, preferably C₁-C₂₀ alkyl or cycloalkyl. The term “alkoxy” denotes straight chain or branched alkoxy, preferably C₁-C₂₀ alkoxy. Examples of alkoxy include methoxy, ethoxy, n-propoxy, isopropoxy and the different butoxy isomers. The term “alkenyl” denotes groups formed from straight chain, branched or cyclic alkenes including ethylenically mono-, di- or poly-unsaturated alkyl or cycloalkyl groups as previously defined, preferably C₂-C₂₀ alkenyl. The term “acyl” either alone or in combination, as in “acyloxy”, “acylthio”, “acylamino” or “diacylamino”, denotes carbamoyl, aliphatic acyl group and acyl group containing an aromatic ring, which is referred to as aromatic acyl or a heterocyclic ring which is referred to as heterocyclic acyl, preferably C₁-C₂₀ acyl.

Agents (R) of formula (I) according to this first aspect can be prepared by a method comprising a step of polymerizing at least one monomer (A) in the presence of a RAFT agent of formula (II)

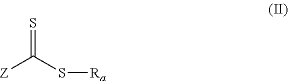

wherein Rₐ and Z are as defined in formula (I), and in the presence of a radical initiator, so as to obtain an intermediate pre-polymer, followed by a step of polymerizing at least one monomer (B), in the presence of said intermediate pre-polymer and in the presence of a radical initiator.

As said, monomer (A) is at least one ethylenically unsaturated monomer having hydrophilic character, while monomer (B) is at least one ethylenically unsaturated monomer having hydrophobic character, whereas the terms “hydrophilic” and “hydrophobic” are used throughout the present specification with their commonly recognised meaning, that is to refer to compounds and/or functional parts of compounds “provided with a tendency to interact with or dissolve in water” (hydrophilic) or “incapable of interacting with or dissolving in water” (hydrophobic).

Any ethylenically unsaturated monomer having hydrophilic character can be used as monomer (A); said hydrophilic character may be conferred by ionisable or non-ionisable functional groups.

By the term “ionisable”, used in connection with the functional group of monomer (A), is meant that said functional group can be ionised to form a cationic or anionic group. Such a functional group will generally be capable of being ionised under acidic or basic conditions through loss or acceptance of a proton. Generally, the ionisable functional groups are acid groups or basic groups. For example, a carboxylic acid functional group may form a carboxylate anion under basic conditions, and an amine functional group may form a quaternary ammonium cation under acidic conditions. The functional groups may also be capable of being ionised through an ion exchange process.

By the term “non-ionisable”, used in connection with the functional group of monomer (A), is meant that said functional group does not have ionisable functional groups. In particular, such a functional group does not have acid groups or basic groups which can lose or accept a proton under acidic or basic conditions, but yet it has sufficient hydrophilic character to interact with or even dissolve into water.

Among non-ionisable monomers (A), mention may be made of 2-hydroxyethyl acrylate, 2-hydroxyethyl methacrylate, poly (ethylene oxide) methyl ether methacrylate (PEOMA), poly (ethylene oxide) methyl ether acrylate (PEOA), N,N-dimethylacrylamide, N-vinyl-2-pyrrolidone.

Yet, it is generally preferred for monomer (A) to include an ionisable functional group.

The ionisable functional group may be a cationic functional group or an anionic functional group.

Among ionisable monomers (A) comprising cationic functional groups, mention may be made of dimethyl amino-ethyl and propyl acrylates and methacrylates, N-acryloylmorpholine, and its quaternary ammonium salts,

Preferred ionisable monomers (A) are selected among those having an anionic functional group or a precursor thereof.

According to such embodiments, monomer (A) is preferably selected from the group consisting of ethylenically unsaturated monomers comprising at least one carboxylic, sulfonic, sulfuric, phosphonic, phosphoric acid functional group, its salt or precursor thereof.

Typically, monomers (A) according to this embodiment are monomers which contain functional groups whose corresponding acid has an acid dissociation constant pKa of less than 6, preferably of less than 5, even more preferably of less than 4.

Among monomers (A) comprising at least one carboxylic functional group or precursor thereof mention may be made for instance of α-β-ethylenically unsaturated carboxylic acids and the corresponding anhydrides, such as acrylic acid, acrylic anhydride, methacrylic acid, methacrylic anhydride, maleic acid, maleic anhydride, fumaric acid, itaconic acid, N-methacryloylalanine, N-acryloylglycine, p-carboxystyrene, and their water-soluble salts. Monomer precursors of carboxylic functional groups may be chosen, such as tert-butyl acrylate or tert-butyl methacrylate, which produce a carboxylic acid functional group, or its salt, by hydrolysis after polymerization. Among the monomers (A) comprising at least one carboxylic functional group, acrylic acid or methacrylic acid may be favoured.

Among monomers (A) comprising at least one sulfuric or sulfonic functional group, or precursors thereof, mention may be made for instance of vinyl sulfonic acid, styrene sulfonic acid, 2-acrylamido-2-methylpropane sulfonic acid, 3-[N-(2-methacryloyloxyethyl)-N,N-dimethylammonio]propane sulfonic acid, 3-[N,N-dimethylvinylbenzylammonio)propane sulfonic acid, 3-[2-(N-methacrylamido)-ethyldimethylammonio]propane sulfonic acid, 3-(methacryloyloxy)propane sulfonic acid, 3-(acryloyloxy)propane sulfonic acid, 2-(methacryloyloxy)ethane sulfonic acid, 2-(acryloyloxy)ethane sulfonic acid, 2-methylenesuccinic acid bis(3-sulfopropyl) ester, 3-[N-(3-methacrylamidopropyl)-N,N-dimethyl]ammoniopropane sulfonic acid, 3-(2-vinylpyridinio)propane sulfonic acid and their corresponding salts and sulfate analogs. Monomers comprising precursors of sulfonic acid functional groups may be chosen, from example, from n-butyl p-styrenesulfonate, neopentyl p-styrene sulfonate, which produces a sulfonic acid functional group, or its salt, by hydrolysis after polymerization.

Notable examples of monomers (A) comprising a phosphonic acid or phosphonic acid precursor are for instance: N-methacrylamidomethylphosphonic acid ester derivatives, in particular the n-propyl ester, the methyl ester, the ethyl ester, the n-butyl ester or the isopropyl ester, and their phosphonic monoacid and diacid derivatives, such as N-methacrylamidomethylphosphonic diacid; N-methacrylamidoethylphosphonic acid ester derivatives, such as N-methacrylamidoethylphosphonic acid dimethyl ester or N-methacrylamidoethylphosphonic acid di(2-butyl-3,3-dimethyl)ester, and their phosphonic monoacid and diacid derivatives, such as N-methacrylamidoethylphosphonic diacid; N-acrylamidomethylphosphonic acid ester derivatives, such as N-acrylamidomethylphosphonic acid dimethyl ester, N-acrylamidomethylphosphonic acid diethyl ester or bis(2-chloropropyl)N-acrylamidomethylphosphonate, and their phosphonic monoacid and diacid derivatives, such as N-acrylamidomethylphosphonic acid; vinylbenzylphosphonate dialkyl ester derivatives, in particular the di(n-propyl), di(isopropyl), diethyl, dimethyl, di(2-butyl-3,3′-dimethyl) and di(t-butyl) ester derivatives, and their phosphonic monoacid and diacid alternative forms, such as vinylbenzylphosphonic diacid; diethyl 2-(4-vinylphenyl)ethanephosphonate; dialkylphosphonoalkyl acrylate and methacrylate derivatives, such as 2-(acryloyloxy)ethylphosphonic acid dimethyl ester and 2-(methyacryloyloxy)ethylphosphonic acid dimethyl ester, 2-(methacryloyloxy)methylphosphonic acid diethyl ester, 2-(methacryloyloxy)methylphosphonic acid dimethyl ester, 2-(methacryloyloxy)propylphosphonic acid dimethyl ester, 2-acryloyloxy)methylphosphonic acid diisopropyl ester or 2-(acryloyloxy)ethylphosphonic acid diethyl ester, and their phosphonic monoacid and diacid alternative forms, such as 2-(methacryloyloxy)ethylphosphonic acid, 2-(methacryloyloxy)methylphosphonic acid, 2-(methacryloyloxy)propylphosphonic acid, 2-(acryloyloxy)propylphosphonic acid and 2-acryloyloxy)ethylphosphonic acid; vinylphosphonic acid, optionally substituted by cyano, phenyl, ester or acetate groups, vinylidenephosphonic acid, in the form of a salt or the form of its isopropyl ester, or bis(2-chloroethyl)vinylphosphonate.

Ethylenically unsaturated monomers (A) can also be chosen from the phosphate analogs of the phosphonate-comprising monomers described above. Mention may be made, as specific phosphate-comprising monomers, of: 2-(methacryloyloxy)ethyl phosphate, 2-(acryloyloxy)ethyl phosphate, 2-(methacryloyloxy)propyl phosphate, 2-(acryloyloxy)propyl phosphate, and acrylates or methacrylates of polyethylene glycol omega phosphates or acrylates or methacrylates of polypropylene glycol omega phosphates.

Advantageously, the monomer (A) is selected without limitation, from the group consisting of acrylic acid, methacrylic acid, vinyl phosphonic acid, vinyl sulfonic acid, styrene sulfonic acid, and 2-acrylamido-2-methylpropane sulfonic acid, their salts or their precursors. Particularly preferred monomers (A) are selected among acrylic acid and methacrylic acid.

Ethylenically unsaturated monomers having a hydrophobic character, referred to as monomers (B) are for instance those selected from the group consisting of: styrene and styrene derivatives, such α-methylstyrene, p-methylstyrene or p-(t-butyl)styrene; alkyl esters of acrylic or methacrylic acid, such as methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate; C₃-C₁₂ vinyl nitriles, e.g. acrylonitrile or methacrylonitrile; vinyl or allyl esters of carboxylic acids, such as vinyl or allyl acetates, propionates, stearates; vinyl halides, allyl halides, vinylidene halides, or vinylaromatic halides, e.g. vinyl chloride, vinylidene chloride or pentafluorostyrene; α-olefins, such as ethylene; conjugated diene monomers, for examples butadiene, isoprene, chloroprene.

Preferred monomers (B) are in particular alkyl esters of acrylic or methacrylic acid, which have the additional advantage of providing sequences -[B]ₘ- which are miscible with vinylidene fluoride polymers.

In preferred embodiments of RAFT agent of formula (I)

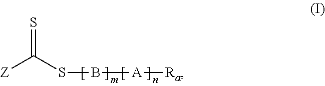

wherein
Rₐ is preferably selected from the group consisting of: —C(CH₃)₂—CH₂CH₂—CO₂H, —CH(CH₃)CO₂H, —CH(CO₂H)CH₂CO₂H, —C(CH₃)₂CO₂H, —CH₂(C₆H₅), —C(CN)(CH₃)CO₂H, —C(CN)(CH₃)CH₂CH₂CO₂H;
-[A]ₙ- preferably represents a sequence of repeating units -A- derived from at least one monomer (A) selected from the group consisting of acrylic acid, methacrylic acid, vinyl phosphonic acid, vinyl sulfonic acid, styrene sulfonic acid, and 2-acrylamido-2-methylpropane sulfonic acid, their salts or their precursors, whereas n is an integer from 2 to 300, preferably from 2 to 250, even from 3 to 200, more preferably from 3 to 150 and even more preferably from 3 to 120;
-[B]ₘ- preferably represents a sequence of recurring units -B- derived from at least one monomer (B) selected from the group consisting of alkyl esters of acrylic or methacrylic acids, whereas m is an integer from 2 to 300, preferably from 2 to 250, even from 3 to 200, more preferably from 3 to 150 and even more preferably from 3 to 120; and
Z is preferably selected from the group consisting of optionally substituted alkylthio groups.

In agent (R), an optimum balance of hydrophilic and hydrophobic character is achieved when the molar ratio between units of the sequence -[A]ₙ- and units of the sequence -[B]ₘ- is between 0.6 and 1.4. When departing from such a range, the amphiphilic character of the polymeric RAFT agent may be decreased, so that the ability of agent (R) to self-assemble and to stabilize the emulsion polymerization may be affected.

Generally, a molar ratio between units of the sequence -[A]ₙ- and units of the sequence -[B]ₘ- of between 0.8 and 1.2 will be preferred.

Agent (R) may be present in the aqueous medium under the form of dispersed particles having an average particle size of less than 100 nm, preferably less than 75 nm, more preferably less than 50 nm.

Particles of agent (R) having an average particle size of 3 to 50 nm, preferably of 5 to 35 nm have been found particularly effective.

Within this context, the expression “average particle size” in connection with the dispersed particles of agent (R) in the aqueous medium is meant to designate the mean diameter Dz, i.e. the scattered light intensity-weighted harmonic mean particle diameter, also referred as z-average diameter, as determined according to the standard ISO 22412:2017, e.g. by using the system NanoZS from Malvern Panalytical.

The mixture (M) comprises at least one fluoromonomer or monomer (F). Monomer mixtures comprising more than one fluoromonomer are generally employed in the method of the present invention.

The expression “fluoromonomer” is used herein according to its usual meaning, that is to say for designating an ethylenically unsaturated monomer comprising at least one fluorine atom.

The monomer (F) is selected generally from the group consisting of:
C₂-C₈ perfluoroolefins, such as tetrafluoroethylene (TFE), hexafluoropropene (HFP);
C₂-C₈ hydrogen-containing fluoroolefins, such as vinyl fluoride, 1,2-difluoroethylene, vinylidene fluoride (VDF), trifluoroethylene (TrFE), pentafluoropropylene, and hexafluoroisobutylene;
(per)fluoroalkylethylenes complying with formula CH₂═CH—R_{f0}, in which R_{f0} is a C₁-C₆ (per)fluoroalkyl or a C₁-C₆ (per)fluorooxyalkyl having one or more ether groups;
chloro- and/or bromo- and/or iodo-C₂-C₆ fluoroolefins, like chlorotrifluoroethylene (CTFE);
fluoroalkylvinylethers complying with formula CF₂═CFOR_{f1} in which R_{f1} is a C₁-C₆ fluoro- or perfluoroalkyl, e.g. —CF₃, —C₂F₅, —C₃F₇;
hydrofluoroalkylvinylethers complying with formula CH₂═CFOR_{f1} in which R_{f1} is a C₁-C₆ fluoro- or perfluoroalkyl, e.g. —CF₃, —C₂F₅, —C₃F₇;
fluoro-oxyalkylvinylethers complying with formula CF₂═CFOX₀, in which X₀ is a C₁-C₁₂ oxyalkyl, or a C₁-C₁₂ (per)fluorooxyalkyl having one or more ether groups, like perfluoro-2-propoxy-propyl;
fluoroalkyl-methoxy-vinylethers complying with formula CF₂═CFOCF₂OR_{f2} in which R_{f2} is a C₁-C₆ fluoro- or perfluoroalkyl, e.g. —CF₃, —C₂F₅, —C₃F₇ or a C₁-C₆ (per)fluorooxyalkyl having one or more ether groups, like —C₂F₅—O—CF₃;
functional fluoro-alkylvinylethers complying with formula CF₂═CFOY₀, in which Y₀ is a C₁-C₁₂ alkyl or (per)fluoroalkyl, or a C₁-C₁₂ oxyalkyl or a C₁-C₁₂ (per)fluorooxyalkyl, said Y₀ group comprising a carboxylic or sulfonic acid group, in its acid, acid halide or salt form;
fluorodioxoles, of formula:

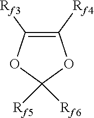

wherein each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃.

The monomer (F) generally includes vinylidene fluoride (VDF). Mixture (M) may include one or more than one monomer (F), being understood that, in preferred embodiments, mixture (M) generally comprises vinylidene fluoride, and may comprise one or more than one monomer (F), as detailed above, different from vinylidene fluoride.

The mixture (M) may comprise at least one additional monomer different from monomer (F), that is to say a monomer free from fluorine, otherwise generally referred to as a hydrogenated monomer. Examples of hydrogenated monomers are notably C₂-C₈ non-fluorinated olefins (Ol), in particular C₂-C₈ non-fluorinated alpha-olefins (Ol), including ethylene, propylene, 1-butene; diene monomers; styrene monomers; with alpha-olefins, as above detailed, being typically used.

The method of the invention is suitable for the manufacture of a large variety of polymers (F), including notably non-melt processable TFE polymers (including PTFE homopolymers and its copolymers comprising low amounts of perfluorinated comonomers), thermoplastic fluoropolymers (e.g. VDF homopolymers and its plastomeric copolymers, copolymers of ethylene with CTFE, ETFE, and mixtures thereof, thermoplastic copolymers of TFE and PAVE, thermoplastic copolymers of TFE and HFP), and fluoroelastomers, in particular vinylidene fluoride (VDF) fluoroelastomers.

Particular combinations of monomers (F) which can be used as mixtures (M) in the method of the present invention, in particular for manufacturing fluoroelastomers, are preferably:
(1) vinylidene fluoride (VDF) containing monomers mixtures [mixtures (M_{VDF})], in which VDF is mixed with at least one comonomer different from VDF and selected from the group consisting of:
(a) C₂-C₈ perfluoroolefins, such as tetrafluoroethylene (TFE), hexafluoropropylene (HFP);
(b) hydrogen-containing C₂-C₈ fluoro-olefins, such as vinyl fluoride (VF), trifluoroethylene (TrFE), perfluoroalkyl ethylenes of formula CH₂═CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per)fluoroalkylvinylethers (PAVE) of formula CF₂═CFOR_{f}, wherein R_{f} is a C₁-C₆ (per)fluoroalkyl group, e.g. CF₃, C₂F₅, C₃F₇;
(e) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;
(f) (per)fluorodioxoles having formula:

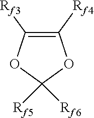

wherein R_{f3}, R_{f4}, R_{f5}, R_{f6}, equal or different from each other, are independently selected among fluorine atoms and C₁-C₆ (per)fluoroalkyl groups, optionally comprising one or more than one oxygen atom, such as notably —CF₃, —C₂F₅, —C₃F₇, —OCF₃, —OCF₂CF₂OCF₃; preferably, perfluorodioxoles;
(g) (per)fluoro-methoxy-vinylethers (MOVE, hereinafter) having formula:

CFX₂═CX₂OCF₂OR″_{f}

wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂═F, H; preferably X₂ is F and R″_{f} is —CF₂CF₃ (MOVE1); —CF₂CF₂OCF₃ (MOVE2); or —CF₃ (MOVE3);
(h) C₂-C₈ non-fluorinated olefins (Ol), for example ethylene and propylene; and
(2) tetrafluoroethylene (TFE) containing monomers mixtures [mixtures (M_{TFE})], in which TFE is mixed with at least one comonomer different from TFE and selected from the group consisting of monomers of classes (a), (c), (d), (e), (f), (g), as above detailed and the followings:
(i) perfluorovinyl ethers containing at least one nitrile group, such as notably those described in patents U.S. Pat. Nos. 4,281,092, 5,447,993 and 5,789,489.

Preferred mixtures (M) for use in the method of the invention are mixtures (M_{VDF}), as described above.

Optionally, the mixture (M) (and/or the mixture (M_{VDF})) may further comprise at least one bis-olefin [bis-olefin (OF)] having general formula:

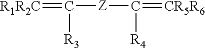

wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per)fluoropolyoxyalkylene radical, e.g. as described in EP 661304 A (AUSIMONT SPA) Jul. 5, 1995.

The bis-olefin (OF) possibly comprised in the mixture (M) (and/or in the mixture (M_{VDF})) is preferably selected from the group consisting of those complying with formulae (OF-1), (OF-2) and (OF-3):

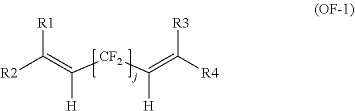

wherein j is an integer between 2 and 10, preferably between 4 and 8, and R1, R2, R3, R4, equal or different from each other, are H, F or C₁₋₅ alkyl or (per)fluoroalkyl group;

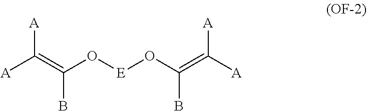

wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

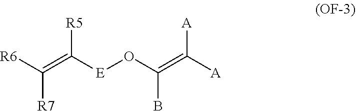

wherein E, A and B have the same meaning as above defined; R5, R6, R7, equal or different from each other, are H, F or C₁₋₅ alkyl or (per)fluoroalkyl group.

When present in the mixture (M) (and/or the mixture (M_{VDF})), the bis-olefin (OF) is present in an amount of 0.01 to 1% moles, with respect to the total amount of monomers of mixture (M) (and/or of mixture (M_{VDF})).

When the method is used for the manufacture of elastomers, the following mixtures (M) can be advantageously used (in mol %):
(i) vinylidene fluoride (VDF) 35-85%, hexafluoropropene (HFP) 10-45%, tetrafluoroethylene (TFE) 0-30%, (per)fluoroalkyl vinyl ethers (PAVE) 0-15%, bis-olefin (OF) 0-5%;
(ii) vinylidene fluoride (VDF) 50-80%, (per)fluoroalkyl vinyl ethers (PAVE) 5-50%, tetrafluoroethylene (TFE) 0-20%, bis-olefin (OF) 0-5%;
(iii) vinylidene fluoride (VDF) 20-30%, C₂-C₈ non-fluorinated olefins (Ol) 10-30%, hexafluoropropene (HFP) and/or (per)fluoroalkyl vinyl ethers (PAVE) 18-27%, tetrafluoroethylene (TFE) 10-30%, bis-olefin (OF) 0-5%;
(iv) tetrafluoroethylene (TFE) 50-80%, (per)fluoroalkyl vinyl ethers (PAVE) 20-50%, bis-olefin (OF) 0-5%;
(v) tetrafluoroethylene (TFE) 45-65%, C₂-C₈ non-fluorinated olefins (Ol) 20-55%, vinylidene fluoride (VDF) 0-30%, bis-olefin (OF) 0-5%;
(vi) tetrafluoroethylene (TFE) 32-60% mol %, C₂-C₈ non-fluorinated olefins (Ol) 10-40%, (per)fluoroalkyl vinyl ethers (PAVE) 20-40%, fluorovinyl ethers (MOVE) 0-30%, bis-olefin (OF) 0-5%;
(vii) tetrafluoroethylene (TFE) 33-75%, (per)fluoroalkyl vinyl ethers (PAVE) 15-45%, vinyl idene fluoride (VDF) 5-30%, hexafluoropropene HFP 0-30%, bis-olefin (OF) 0-5%;
(viii) vinylidene fluoride (VDF) 35-85%, (per)fluoro-methoxy-vinylether (MOVE) 5-40%, (per)fluoroalkyl vinyl ethers (PAVE) 0-30%, tetrafluoroethylene (TFE) 0-40%, hexafluoropropene (HFP) 0-30%, bis-olefin (OF) 0-5%;
(ix) tetrafluoroethylene (TFE) 20-70%, (per)fluoro-methoxy-vinylether (MOVE) 30-80%, (per)fluoroalkyl vinyl ethers (PAVE) 0-50%, bis-olefin (OF) 0-5%.

In the above mixtures, the expressions (per)fluoroalkyl vinyl ethers (PAVE), bis-olefin (OF), (per)fluoro-methoxy-vinylether (MOVE), C₂-C₈ non-fluorinated olefins (Ol) have the meaning defined above.

Mixture (M_{VDF}) of type (i), (ii), (iii), (v) (with VDF is higher than 0), (vii) and (viii) are particularly preferred for use in the method of the present invention.

Still, when the mixture (M) (and/or mixture (M_{VDF})) is intended for the manufacture of a fluoroelastomer via the method of the present invention, cure-site containing monomers can be used.

Among cure-site containing monomers, mention can be notably made of:
(CSM-1) iodine or bromine containing monomers of formula:

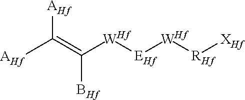

wherein each of A_{Hf}, equal to or different from each other and at each occurrence, is independently selected from F, Cl, and H; B_{Hf} is any of F, Cl, H and OR^{Hf}_{B}, wherein R^{Hf}_{B} is a branched or straight chain alkyl radical which can be partially, substantially or completely fluorinated or chlorinated; each of W^{Hf} equal to or different from each other and at each occurrence, is independently a covalent bond or an oxygen atom; E_{Hf} is a divalent group having 2 to 10 carbon atom, optionally fluorinated; R_{Hf} is a branched or straight chain alkyl radical, which can be partially, substantially or completely fluorinated; and R_{Hf} is a halogen atom selected from the group consisting of Iodine and Bromine; which may be inserted with ether linkages; preferably E is a —(CF₂)ₘ— group, with m being an integer from 3 to 5;
(CSM-2) ethylenically unsaturated compounds comprising nitrile groups, possibly fluorinated.

Among cure-site containing monomers of type (CSM1), preferred monomers are those selected from the group consisting of:
(CSM1-A) iodine-containing perfluorovinylethers of formula:

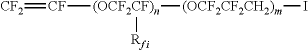

with m being an integer from 0 to 5 and n being an integer from 0 to 3, with the provisio that at least one of m and n is different from 0, and R_{fi} being F or CF₃; (as notably described in patents U.S. Pat. No. 4,745,165 (AUSIMONT SPA) May 17, 1988, U.S. Pat. No. 4,564,662 (MINNESOTA MINING) Jan. 14, 1986 and EP 199138 A (DAIKIN IND LTD) Oct. 29, 1986); and
(CSM-1B) iodine-containing ethylenically unsaturated compounds of formula: CX¹X²═CX³—(CF₂CF₂)ₚ—I, wherein each of X¹, X² and X³, equal to or different from each other, are independently H or F; and p is an integer from 1 to 5; among these compounds, mention can be made of CH₂═CHCF₂CF₂I, I(CF₂CF₂)₂CH═CH₂, ICF₂CF₂CF═CH₂, I(CF₂CF₂)₂CF═CH₂;
(CSM-1C) iodine-containing ethylenically unsaturated compounds of formula: CHR═CH—Z—CH₂CHR—I, wherein R is H or CH₃, Z is a C₁-C₁₈ (per)fluoroalkylene radical, linear or branched, optionally containing one or more ether oxygen atoms, or a (per)fluoropolyoxyalkylene radical; among these compounds, mention can be made of CH₂═CH—(CF₂)₄CH₂CH₂I, CH₂═CH—(CF₂)₆CH₂CH₂I, CH₂═CH—(CF₂)₈CH₂CH₂I, CH₂═CH—(CF₂)₂CH₂CH₂I;
(CSM-1D) bromo and/or iodo alpha-olefins containing from 2 to 10 carbon atoms such as bromotrifluoroethylene or bromotetrafluorobutene described, for example, in U.S. Pat. No. 4,035,565 (DU PONT) Jul. 12, 1977 or other compounds bromo and/or iodo alpha-olefins disclosed in U.S. Pat. No. 4,694,045 (DU PONT) Sep. 15, 1987.

Among cure-site containing monomers of type (CSM2), preferred monomers are those selected from the group consisting of:
(CSM2-A) perfluorovinyl ethers containing cyanide groups of formula CF₂═CF—(OCF₂CFX^{CN})ₘ—O—(CF₂)ₙ—CN, with X^{CN} being F or CF₃, m being 0, 1, 2, 3 or 4; n being an integer from 1 to 12;
(CSM2-B) perfluorovinyl ethers containing cyanide groups of formula CF₂═CF—(OCF₂CFX^{CN})_{m′}—O—CF₂—CF(CF₃)—CN, with X^{CN} being F or CF₃, m′ being 0, 1, 2, 3 or 4.

Specific examples of cure-site containing monomers of type CSM2-A and CSM2-B suitable to the purposes of the present invention are notably those described in patents U.S. Pat. No. 4,281,092 (DU PONT) Jul. 28, 1981, U.S. Pat. No. 4,281,092 (DU PONT) Jul. 28, 1981, U.S. Pat. No. 5,447,993 (DU PONT) Sep. 5, 1995 and U.S. Pat. No. 5,789,489 (DU PONT) Aug. 4, 1998

Further, in addition, in the method of the present invention, the aqueous medium may additionally comprise anyone of:
iodinated and/or brominated chain-transfer agent(s); suitable chain-chain transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2 (see, for example, patents U.S. Pat. No. 4,243,770 (DAIKIN IND LTD) Jan. 6, 1981 and U.S. Pat. No. 4,943,622 (NIPPON MEKTRON KK) Jul. 24, 1990); and
alkali metal or alkaline-earth metal iodides and/or bromides, such as described notably in patent U.S. Pat. No. 5,173,553 (AUSIMONT SRL) Dec. 22, 1992.

Iodinated iodinated and/or brominated chain-transfer agents as above detailed are particularly preferred.

Those agents are particularly useful for the aim of including additional iodine and/or bromine cure sites as terminal groups of the polymer (F).

The step of polymerizing mixture (M) may be carried out at a temperature between 10 to 150° C., preferably 20° C. to 110° C. and at a pressure typically between 2 and 30 bar, in particular 15 to 30 bar.

The temperature may be varied during the step of polymerizing monomer (M) e.g. for influencing the molecular weight distribution, i.e., to obtain a broad molecular weight distribution or to obtain a bimodal or multimodal molecular weight distribution.

The pH of the aqueous medium in the step of polymerizing mixture (M) may be in the range of pH 2-10, preferably 3-9, most preferably 4-8.

The aqueous emulsion polymerization is typically initiated by a radical initiator including any of the initiators known for initiating a free radical polymerization of fluorinated monomers. Suitable initiators include peroxides and azo compounds and redox based initiators. Specific examples of peroxide initiators include hydrogen peroxide, sodium or barium peroxide, diacylperoxides such as diacetylperoxide, disuccinyl peroxide, dipropionylperoxide, dibutyrylperoxide, dibenzoylperoxide, benzoylacetylperoxide, diglutaric acid peroxide and dilaurylperoxide, and further per-acids and salts thereof such as e.g. ammonium, sodium or potassium salts. Examples of per-acids include peracetic acid. Esters of the peracid can be used as well and examples thereof include tert.-butylperoxyacetate and tert.-butylperoxypivalate. Examples of inorganic include for example ammonium-alkali- or earth alkali salts of persulfates, permanganic or manganic acid or manganic acids. A persulfate initiator, e.g. ammonium persulfate (APS), can be used on its own or may be used in combination with a reducing agent. Similarly, one organic radical initiator can be used alone or in combination with a reducing agent: techniques combining a radical initiator and a reducing agent are generally referred to as “redox” techniques.

Suitable reducing agents for redox techniques include bisulfites such as for example ammonium bisulfite or sodium metabisulfite, thiosulfates such as for example ammonium, potassium or sodium thiosulfate, hydrazines, azodicarboxylates and azodicarboxyldiamide (ADA). A metal salt catalyst such as for example copper, iron or silver salts may be added. Further reducing agents that may be used include sodium formaldehyde sulfoxylate (Rongalit) or fluoroalkyl sulfinates, e.g. as disclosed in U.S. Pat. No. 5,285,002. Also, use can be made, as reducing agents, of compounds bearing at least one sulfinic acid group, such as compounds of formula:

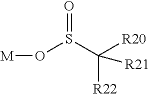

wherein:
M is a hydrogen atom, an ammonium ion, a monovalent metal ion;
R20 is —OH or —N(R4)(R5) where each of R4 and R5, identical or different from one another, are hydrogen atom or linear or branched alkyl chain having from 1 to 6 carbon atoms;
R21 is hydrogen atom, linear or branched alkyl group having from 1 to 6 carbon atoms, 5- or 6-membered cycloalkyl group, 5- or 6-membered aryl group;
R22 is —COOM, —SO₃M, —C(═O)R4, —C(═O)N(R4)(R5), —C(═O)OR4, wherein M, R4 and R5 are as defined above. Reducing agents of this type are particularly advantageous when used in combination with organic radical initiators, as described notably in U.S. Pat. No. 11,180,592.

The reducing agent is generally understood to reduce the half-life time of the radical initiator, and hence to enable notably polymerizing with higher kinetics and/or at lower temperatures.

The step of terminating the polymerization can be carried out according to known means. For instance, by degassing unreacted gaseous monomers, by decreasing the temperature, by interrupting any further addition of initiator, and/or by any combination thereof.

As a result of the method of the present invention, a latex of fluoropolymer [polymer (F)] is obtained.

The method of the present invention is particularly applicable to the manufacture of fluoroelastomers. The expression “fluoroelastomer” is intended to designate a fluoropolymer resin serving as a base constituent for obtaining a true elastomer, said fluoropolymer resin comprising more than 10% wt, preferably more than 30% wt, of recurring units derived from at least one fluoromonomer, as described above.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Fluoroelastomers are in general amorphous products or products having a low degree of crystallinity (crystalline phase less than 20% by volume) and a glass transition temperature (T_{g}) below room temperature. In most cases, the fluoroelastomer (A) has advantageously a T_{g} below 10° C., preferably below 5° C., more preferably 0° C., and has advantageously a heat of fusion of less than 10 J/g, preferably of less than 7 J/g, more preferably of less than 5 J/g.

The product resulting from the method of the invention is a fluoropolymer latex, or in other terms, an aqueous dispersion of fluoropolymer, which means that polymer (F) particles are stably dispersed in an aqueous medium, so that settling of the particles does not occur within the time when the dispersion will be used.

For the purpose of the invention the term “particle” is intended to denote a mass of material that, from a geometrical point of view, has a definite three-dimensional volume and shape, characterized by three dimensions, wherein none of said dimensions exceed the remaining two other dimensions of more than 1000%. Particles are generally not equidimensional, i.e. that are longer in one direction than in others, and include different shapes, such as spheroidal, rod-like, cobblestone, and the like.

The particles of polymer (F) in the aqueous dispersion or latex, resulting from the method of the invention, possess an average particle size of at least 20 nm, preferably at least 30 nm, more preferably at least 50 nm, and/or of at most 450 nm, preferably at most 400 nm, most preferably at most 350 nm. Average particle size of particles of polymer (F) is measured by a Laser light diffusion-based equipment, in particular on Photon Correlation Spectroscopy, equipped with Brookhaven 2030 AT model correlator and Argon Laser light source having a wavelength of 514.5 nm by Spectra-Phisics. The latex specimens to be subjected to measurement, are suitably diluted with water bidistilled and filtered at 0.2 μm on Millipore filter. The scattering measurement is carried out at room temperature and at an angle of 90°. The latex particle diameter is obtained by the cumulant method.

The aqueous dispersion may be a crude polymerization latex, directly obtained from the method of the invention, after terminating the polymerization step and venting unreacted monomers, or can be obtained from said crude polymerization latex by post-treatment, such as e.g. upconcentration methods (clouding, ultrafiltration . . . ), intended to increase the polymer (F) concentration in the aqueous medium.

At the end of the process the fluoropolymer may be treated according to known procedures to remove chain-end groups deriving from the RAFT agent.

At the end of the process the fluoropolymer may be either isolated as a solid from the aqueous medium of its latex or may be used as a latex, i.e. as an aqueous dispersion. In this latter case residual monomers are stripped before the dispersion subsequent use.

Conventional techniques can be used for the isolation of the fluoropolymer from the aqueous medium or for the formulation of the fluoropolymer latex.

The invention will be now described in more detail with reference to the following examples, whose purpose is merely illustrative and not intended to limit the scope of the invention. Should the disclosure of any patents, patent applications, and publications which are incorporated herein by reference conflict with the description of the present application to the extent that it may render a term unclear, the present description shall take precedence.

### EXAMPLES

### Materials

The following materials were used in the examples:
ACPA: 4,4′-azobis-4-cyanopentanoic acid (purity>98%, Merck)
CTBPA: 4-cyano-4-thiothiobutylsulfanyl pentanoic acid (purity =96%, DSK Innosciences)
MAA: Methacrylic Acid (purity>99%, Merck)
MMA: Methyl Methacrylate (Aldrich, purity>99%, Merck)

### Preparative Example 1: Synthesis of Polymeric Agent (R)

### Step 1a: PMAA-TTC mCTA

353 g of deionized water, 1.54 g of 4,4′-Azobis(4-cyanopentanoic acid) (ACP), 100 g of methacrylic acid (MAA) and 16.35 of 4-cyano-4-thiothiobutylsulfanyl pentanoic acid (CTBPA) were introduced into a 0.5 L glass reactor, equipped with a double jacket, a mechanical stirrer and a condenser. The reactor was closed and the mixture was deoxygenated by nitrogen bubbling for 30 minutes. The temperature in the reactor was then increased to 80° C. and maintained at this temperature for 3 hours. The mixture was then cooled to 25° C. and a yellow solution of macromolecular chain transfer agent (mCTA) PMAA-TTC was discharged. The solid content of the obtained yellow solution was measured by thermogravimetry. The residual MAA content and the molecular weight were determined by HPLC and GPC respectively.

Reaction scheme is depicted below:

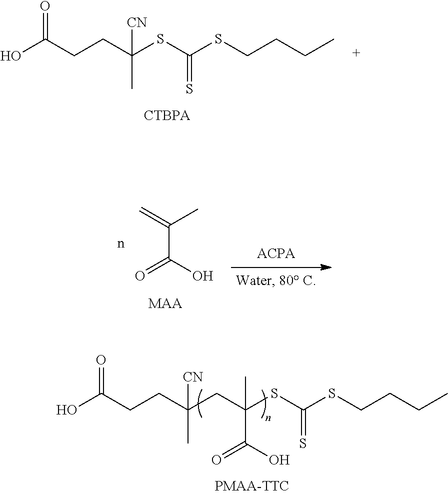

### Step 1b: PMAA-PMMA-TTC

300 g of deionized water and 80.1 g of aqueous solution of PMAA-TTC were introduced into a 0.5 L glass reactor, equipped with a double jacket, a mechanical stirrer and a condenser. The reactor was closed and the mixture was deoxygenated by nitrogen bubbling for 30 minutes. The temperature in the reactor was then increased to 80° C. in 30 minutes and when the temperature in the reactor reached 80° C., 7.2 g of methyl methacrylate (MMA) were added shotwise. An aqueous solution (40.25 g) containing 0.51 of ACP and 0.58 g of NaHCO₃ was added shotwise. The mixture was then maintained at 80° C. for 2 hours. The mixture was cooled to 25° C. and a yellow dispersion was discharged.

The solid content (SC) of the dispersion was measured by thermogravimetry and the particle size (Dz) was measured by dynamic light scattering (DLS), as specified above (SC=13-14 wt %, Dz=12-13 nm).

Reaction scheme is depicted below:

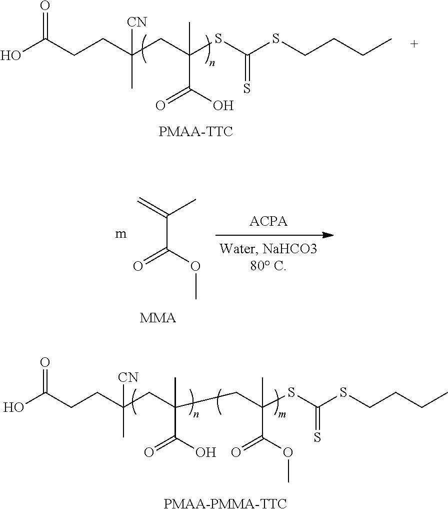

### Example 2

3.0 L of demineralized water were introduced in a previously evacuated 5 L vertical autoclave, equipped with a stirrer operating at 630 RPM. 30.0 g of polymeric agent (R) as obtained from preparative example 1 (13.9% w concentration) were added to the reactor. The autoclave was then heated to 80° C. and maintained at such temperature for the entire duration of the reaction. The pressure of the autoclave was increased by 10.7 bar by feeding HFP monomer. A gaseous mixture of the following monomers was fed to the autoclave so as to bring the pressure to 26 bar: vinylidene fluoride (VDF) 70.5% by moles, hexafluoropropene (HFP) 18.5% by moles and tetrafluoroethylene (TFE) 11.0% by moles. Then, 2.87 g of C₄F₈I₂ and 0.23 g of bis-olefin of formula CH₂═CH—(CF₂)₆—CH═CH₂ (bis-olefin, hereinafter) were introduced. Finally, 250 mL of an ammonium persulfate (APS) aqueous solution (52 g/L) was introduced. After polymerization initiation, the VDF/HFP/TFE mixture was continuously fed to keep a constant pressure of 26 bar, and a total of 4.07 g of bis-olefin were added in 19 steps. At a monomer mix conversion of about 260 g, 4.5 g of C₄F₈I₂ were added. A final aliquot of 2.46 g of C₄F₈I₂ was introduced at a monomer mix conversion of about 1040 g.

The polymerization was continued until an overall monomer consumption of 1300 g was reached after 115 minutes; at this point, stirring was stopped, the autoclave was cooled and depressurized, and a latex was discharged and degassed. The obtained solid content was 30.3% by weight. Average particle size measured by LLS was 209±3 nm (PDI=0.06). The internal stability test carried out on 300 mL of latex resulted in a solid content reduction of 5% over the initial solid content value after 120 minutes, which is an indication of a very good latex stability. After coagulation with a Al₂(SO₄)₃ solution and drying in an oven at 90° C., a Mooney viscosity (1+10@120° C.) of 25.1 MU was obtained. Polymer composition determined by NMR was 68.2% mol VDF, 21.1% mol HFP, 10.7% mol TFE. Polymer chain ends, also determined by NMR, were quantified as follows: 17 mmol/Kg —CF₂H, 3 mmol/Kg —CF₂CH₃, 27 mmol/Kg —CH₂I and 6 mmol/Kg —CH₂OH.

### Comparative Example 3

3.0 L of demineralized water were introduced in a previously evacuated 5 L vertical autoclave, equipped with a stirrer operating at 630 RPM. The autoclave was then heated to 80° C. and maintained at such temperature for the entire duration of the reaction. The pressure of the autoclave was increased by 10.6 bar by feeding HFP monomer. A gaseous mixture of the following monomers was fed to the autoclave so as to bring the pressure to 26 bar: vinylidene fluoride (VDF) 48.5% by moles, hexafluoropropene (HFP) 26.5% by moles and tetrafluoroethylene (TFE) 25.0% by moles.

Then, 1.63 g of C₄F₈I₂ and 0.23 g of bis-olefin were introduced. Finally, 40 mL of an APS aqueous solution (25 g/L) was introduced. After polymerization initiation, the VDF/HFP/TFE mixture was continuously fed to keep a constant pressure of 26 bar, and a total of 4.07 g of bis-olefin were added in 19 steps. At a monomer mix conversion of 240 g, 5.3 g of C₄F₈I₂ were added. A final aliquot of 4.5 g of C₄F₈I₂ was introduced at a monomer mix conversion of 960 g.

The polymerization was continued until an overall monomer consumption of 1200 g was reached after 275 minutes; at this point, stirring was stopped, the autoclave was cooled and depressurized, and a latex was discharged and degassed.

The obtained solid content was 24.0% by weight. Average particle size measured by LLS was 236±7 nm (PDI=0.03). The internal stability test carried out on 300 mL of latex resulted in a solid content reduction of 40% over the initial solid content value after 90 minutes, i.e. showing a poor latex stability. After coagulation with a Al₂(SO₄)₃ solution and drying in an oven at 90° C., a Mooney viscosity (1+10@120° C.) of 33.8 MU was obtained. Polymer composition determined by NMR was 52.5% mol VDF, 21.9% mol HFP, 25.6% mol TFE. Polymer chain ends, also determined by NMR, were quantified as follows: 5 mmol/Kg —CF₂H, 25 mmol/Kg —CH₂I and 5 mmol/Kg —CH₂OH.

### Comparative Example 4

3.0 L of demineralized water were introduced in a previously evacuated 5 L vertical autoclave, equipped with a stirrer operating at 630 RPM. The autoclave was then heated to 80° C. and maintained at such temperature for the entire duration of the reaction. The pressure of the autoclave was increased by 10.7 bar by feeding HFP monomer. A gaseous mixture of the following monomers was fed to the autoclave so as to bring the pressure to 26 bar: vinylidene fluoride (VDF) 70.5% by moles, hexafluoropropene (HFP) 18.5% by moles and tetrafluoroethylene (TFE) 11.0% by moles.

Then, 1.93 g of C₄F₈I₂ and 0.21 g of bis-olefin were introduced. Finally, 90 mL of an APS aqueous solution (50 g/L) was introduced. After polymerization initiation, the VDF/HFP/TFE mixture was continuously fed to keep a constant pressure of 26 bar, and a total of 4.08 g of bis-olefin were added in 19 steps. At a monomer mix conversion of 260 g, 5.79 g of C₄F₈I₂ were added. A final aliquot of 5.15 g of C₄F₈I₂ was introduced at a monomer mix conversion of 1040 g.

The polymerization was continued until an overall monomer consumption of 1300 g was reached after 89 minutes; at this point, stirring was stopped, the autoclave was cooled and depressurized, and a latex was discharged and degassed. The obtained solid content was 31.0% by weight. Average particle size measured by LLS was 344±8 nm (PDI=0.08). The internal stability test carried out on 300 mL of latex resulted in a solid content reduction of 32% over the initial solid content value after 120 minutes, i.E. showing poor latex stability. After coagulation with a Al₂(SO₄)₃ solution and drying in an oven at 90° C., a Mooney viscosity (1+10@120° C.) of 29.3 MU was obtained. Polymer composition determined by NMR was 68.8% mol VDF, 20.1% mol HFP, 11.1% mol TFE. Polymer chain ends, also determined by NMR, were quantified as follows: 17 mmol/Kg —CF₂H, 24 mmol/Kg —CH₂I, 3 mmol/Kg —CF₂CH₃, and 4 mmol/Kg —CH₂OH.

### Comparative Example 5

11.0 L of demineralized water were introduced in a previously evacuated 22 L vertical autoclave, equipped with a stirrer operating at 500 RPM. The autoclave was then heated to 80° C. and maintained at such temperature for the entire duration of the reaction. The pressure of the autoclave was increased by 10.7 bar by feeding HFP monomer. A gaseous mixture of the following monomers was fed to the autoclave so as to bring the pressure to 26 bar: vinylidene fluoride (VDF) 70.5% by moles, hexafluoropropene (HFP) 18.5% by moles and tetrafluoroethylene (TFE) 11.0% by moles.

Then, 8.15 g of C₄F₈I₂ and 0.92 g of bis-olefin were introduced. Then, 50 mL of an APS aqueous solution (20 g/L) was introduced. An aqueous solution of t-BHP (7.0 g/L) and an aqueous solution of Bruggolite E28 (2.0 g/L) were introduced separately but simultaneously in the reactor at a nominal flow rate of 92 mL/h and 795 mL/h, respectively, and their feeding was kept constant through the reaction. After polymerization initiation, the VDF/HFP/TFE mixture was continuously fed to keep a constant pressure of 26 bar, and a total of 17.4 g of bis-olefin were added in 19 steps. At a monomer mix conversion of 1104 g, 24.0 g of C₄F₈I₂ were added. A final aliquot of 21.9 g of C₄F₈I₂ was introduced at a monomer mix conversion of 4416 g.

The polymerization was continued until an overall monomer consumption of 5520 g was reached after 218 minutes, and a total of 375 mL of t-BHP solution and 2955 mL of Bruggolite E28 solution were added; at this point, stirring was stopped, the autoclave was cooled and depressurized, and a latex was discharged and degassed. The obtained solid content was 29.6% by weight. Average particle size measured by LLS was 398±5 nm (PDI=0.05). The latex was diluted with demineralized water to 20% solid content, and the internal stability test carried out on 300 mL of diluted latex resulted in a solid content reduction of 53% over the initial solid content value after 120 minutes, i.e. a poor latex stability. After coagulation with a Al₂(SO₄)₃ solution and drying in an oven at 90° C., a Mooney viscosity (1+10@120° C.) of 19 MU was obtained. Polymer composition determined by NMR was 69.2% mol VDF, 19.3% mol HFP, 11.5% mol TFE. Polymer chain ends, also determined by NMR, were quantified as follows: 13 mmol/Kg —CF₂H, 33 mmol/Kg —CH₂I, 3 mmol/Kg —CF₂CH₃, and <1 mmol/Kg —CH₂OH.

### Example 2

12.5 L of demineralized water were introduced in a previously evacuated 22 L vertical autoclave, equipped with a stirrer operating at 500 RPM. 43 g of seed dispersion (13.9% w concentration) were added to the reactor. The autoclave was then heated to 80° C. and maintained at such temperature for the entire duration of the reaction. The pressure of the autoclave was increased by 10.7 bar by feeding HFP monomer. A gaseous mixture of the following monomers was fed to the autoclave so as to bring the pressure to 26 bar: vinylidene fluoride (VDF) 70.5% by moles, hexafluoropropene (HFP) 18.5% by moles and tetrafluoroethylene (TFE) 11.0% by moles.

Then, 8.75 g of C₄F₈I₂ were introduced. Then, 50 mL of an APS aqueous solution (20 g/L) was introduced. Finally, an aqueous solution of t-BHP (9.5 g/L) and an aqueous solution of Bruggolite E28 (23.6 g/L) were introduced separately but simultaneously in the reactor at a nominal flow rate of 75 mL/h, and their feeding was kept constant through the reaction. After polymerization initiation, the VDF/HFP/TFE mixture was continuously fed to keep a constant pressure of 26 bar, and a total of 19.9 g of bis-olefin were added in 20 steps. At a monomer mix conversion of 1200 g, 26.2 g of C₄F₈I₂ were added. A final aliquot of 23.3 g of C₄F₈I₂ was introduced at a monomer mix conversion of 4800 g.

The polymerization was continued until an overall monomer consumption of 6000 g was reached after 373 minutes, and a total of 455 mL of t-BHP and 455 mL of Bruggolite E28 were added; at this point, stirring was stopped, the autoclave was cooled and depressurized, and a latex was discharged and degassed. The obtained solid content was 32.0% by weight. Average particle size measured by LLS was 251±8 nm (PDI=0.05). The latex was diluted with demineralized water to 20% solid content, and the internal stability test carried out on 300 mL of diluted latex resulted in a solid content reduction of 17% over the initial solid content value after 120 minutes, which is considered a relatively good latex stability. After coagulation with a Al₂(SO₄)₃ solution and drying in an oven at 90° C., a Mooney viscosity (1+10@120° C.) of 26 MU was obtained. Polymer composition determined by NMR was 69.5% mol VDF, 19.0% mol HFP, 11.4% mol TFE. Polymer chain ends, also determined by NMR, were quantified as follows: 13 mmol/Kg —CF₂H, 29 mmol/Kg —CH₂I, 2 mmol/Kg —CF₂CH₃, and <1 mmol/Kg —CH₂OH.

1. A method for the emulsion polymerization of at least one fluoromonomer, said method comprising:
polymerizing a monomer mixture, mixture (M), comprising at least one fluoromonomer, monomer (F), and optionally at least one additional monomer, in an aqueous medium comprising an amphiphilic polymeric RAFT agent of formula (I), agent (R): 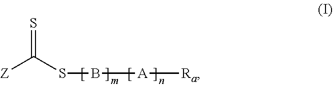
where:
Rₐ is an organic group optionally substituted with one or more hydrophilic groups;
-[A]ₙ- represents a sequence of repeating units -A- derived from at least one ethylenically unsaturated monomer having hydrophilic character, monomer (A), whereas n is an integer from 2 to 300;
-[B]ₘ- represents a sequence of recurring units -B- derived from at least one ethylenically unsaturated monomer having hydrophobic character, monomer (B), whereas m is an integer from 2 to 300; and
Z is selected from the group consisting of optionally substituted alkoxy, optionally substituted aryloxy, optionally substituted heterocyclyl, optionally substituted alkylthio, optionally substituted arylalkylthio, dialkoxy- or diaryloxy-phosphinyl [—P(═O)(OR⁴)₂], dialkyl- or diaryl-phosphinyl [—P(═O)R⁴₂], where R⁴ is selected from the group consisting of optionally substituted C₁-C₁₈ alkyl, optionally substituted C₂-C₁₈ alkenyl, optionally substituted aryl, optionally substituted heterocyclyl, optionally substituted aralkyl, optionally substituted alkaryl, optionally substituted acylamino, optionally substituted acylimino, optionally substituted amino, a polymer chain formed by any mechanism; and wherein Z may be additionally selected from the group consisting of optionally substituted alkyl, preferably optionally substituted C₁-C₂₀ alkyl, optionally substituted aryl, and optionally substituted arylalkyl; Optional substituents for R⁴ and Z groups include epoxy, hydroxy, alkoxy, acyl, acyloxy, carboxy (and its salts), sulfonic acid (and its salts), alkoxy- or aryloxy-carbonyl, isocyanato, cyano, silyl, halo, and dialkylamino; and
terminating the polymerization and recovering a latex of fluoropolymer, polymer (F).

2. The method of claim 1, wherein Z is selected from the group consisting of:
—R⁵, —OR⁵, —SR⁵, where R⁵ is an optionally substituted C₁-C₂₀ alkyl; —NR⁵R⁶ wherein R⁵ is as defined and R⁶ is selected from optionally substituted C₁-C₂₀ and alkyl optionally substituted aryl; and 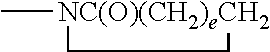
wherein e is an integer from 2 to 4; and/or wherein Z is selected from the group consisting of —OR⁵, —SR⁵, where R⁵ is an optionally substituted C₁-C₂₀ alkyl; —NR⁵R⁶ wherein R⁵ is as defined and R⁶ is selected from optionally substituted C₁-C₂₀ and alkyl optionally substituted aryl; and 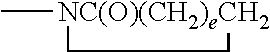
wherein e is an integer from 2 to 4; and/or wherein Z is selected from the group consisting of —SCH₂(C₆H₅), —S(CH₂)ᵤCO₂H wherein u is an integer from 2 to 11, —OC_{z}H_{2z+1}, —SC_{z}H_{2z+1}, wherein z is an integer from 1 to 12, preferably from 2 to 12, —SCH₂CH₂OH, —OCH₂CF₃, —N(C₆H₅)(CH₃); and/or
wherein Rₐ is selected from the group consisting of C₁-C₆ alkyl, C₁-C₆ alkoxy, aryl or heteroaryl, each of which may be substituted with one or more hydrophilic groups selected from —CO₂H, —CO₂R, —CN, —SO₃H, —OSO₃H, —SOR, —SO₂R, —OP(OH)₂, —P(OH)₂, —PO(OH)₂, —OH, —OR, —(OCH₂—CHR⁰)_{w}—OH, —(OCH₂—CHR⁰)_{w}—OR, —CONH₂, CONHR¹, CONR¹R², —NR¹R², —NR¹R²R³, where R is selected from C₁-C₆ alkyl, R⁰ is selected from hydrogen or R, w is an integer from 1 to 10, R¹, R² and R³ are independently selected from C₁-C₆ alkyl and aryl which are optionally substituted with one or more hydrophilic substituent selected from —CO₂H, —SO₃H, —OSO₃H, —OH, —(OCH₂CHR⁰)_{w}—OH, —CONH₂, —SOR and SO₂R, and salts thereof, wherein R, R⁰ and w are as defined above; and/or wherein Rₐ is selected, without limitation, from the group consisting of: —C(CH₃)₂—CH₂CH₂—CO2H, —CH(CH₃)CO₂H, —CH(CO₂H)CH₂CO₂H, —C(CH₃)₂CO₂H, —CH₂(C₆H₅), —C(CN)(CH₃)CO₂H, —C(CN)(CH₃)CH₂CH₂CO₂H.

3. The method of claim 1, wherein agent (R) of formula (I) is prepared by a method comprising a step of polymerizing at least one monomer (A) in the presence of a RAFT agent of formula (II): 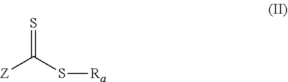
wherein Rₐ and Z are as defined in formula (I); and in the presence of a radical initiator, so as to obtain an intermediate pre-polymer, followed by a step of polymerizing at least one monomer (B), in the presence of said intermediate pre-polymer and in the presence of a radical initiator, and/or
wherein agent (R) is present under the form of particles having an average particle size of 3 to 50 nm, measured as mean diameter Dz, i.e. the scattered light intensity-weighted harmonic mean particle diameter, also referred as z-average diameter, as determined according to the standard ISO 22412:2017.

4. The method of claim 1, wherein monomer (A) comprises an ionisable functional group; and/or wherein monomer (A) comprises an ionisable functional group selected from the group consisting of a cationic functional group or an anionic functional group.

5. The method of claim 4, wherein the monomer (A) comprises cationic functional groups, and/or wherein monomer (A) comprises at least one of dimethyl amino-ethyl and propyl acrylates and methacrylates, N-acryloylmorpholine, and its quaternary ammonium salts.

6. The method of claim 4, wherein the monomer (A) comprises anionic functional groups, and/or wherein monomer (A) is selected from the group consisting of ethylenically unsaturated monomers comprising at least one carboxylic, sulfonic, sulfuric, phosphonic, phosphoric acid functional group, its salt or precursor thereof.

7. The method of claim 6, wherein:
monomer (A) comprises at least one carboxylic functional group or precursor thereof and is selected from the group consisting of α-β-ethylenically unsaturated carboxylic acids and the corresponding anhydrides acrylic acid, acrylic anhydride, methacrylic acid, methacrylic anhydride, maleic acid, maleic anhydride, fumaric acid, itaconic acid, N-methacryloylalanine, N-acryloylglycine, p-carboxystyrene, and their water-soluble salts; tert-butyl acrylate and tert-butyl methacrylate; and/or
monomer (A) comprises at least one sulfuric or sulfonic functional group, or precursors thereof, and is selected from the group consisting of vinyl sulfonic acid, styrene sulfonic acid, 2-acrylamido-2-methylpropane sulfonic acid, 3-[N-(2-methacryloyloxyethyl)-N,N-dimethylammonio]propane sulfonic acid, 3-[N,N-dimethylvinylbenzylammonio)propane sulfonic acid, 3-[2-(N-methacrylamido)-ethyldimethylammonio]propane sulfonic acid, 3-(methacryloyloxy)propane sulfonic acid, 3-(acryloyloxy)propane sulfonic acid, 2-(methacryloyloxy)ethane sulfonic acid, 2-(acryloyloxy)ethane sulfonic acid, 2-methylenesuccinic acid bis(3-sulfopropyl) ester, 3-[N-(3-methacrylamidopropyl)-N,N-dimethyl]ammoniopropane sulfonic acid, 3-(2-vinylpyridinio)propane sulfonic acid and their corresponding salts and sulfate analogs, n-butyl p-styrenesulfonate, and neopentyl p-styrene sulfonate; and/or
monomer (A) comprises a phosphonic acid or phosphonic acid precursor group and is selected from the group consisting of N-methacrylamidomethylphosphonic acid ester derivatives the n-propyl ester, the methyl ester, the ethyl ester, the n-butyl ester or the isopropyl ester, and their phosphonic monoacid and diacid derivatives, N-methacrylamidomethylphosphonic diacid; N-methacrylamidoethylphosphonic acid ester derivatives, N-methacrylamidoethylphosphonic acid dimethyl ester or N-methacrylamidoethylphosphonic acid di(2-butyl-3,3-dimethyl)ester, and their phosphonic monoacid and diacid derivatives, N-methacrylamidoethylphosphonic diacid; N-acrylamidomethylphosphonic acid ester derivatives, N-acrylamidomethylphosphonic acid dimethyl ester, N-acrylamidomethylphosphonic acid diethyl ester or bis(2-chloropropyl)N-acrylamidomethylphosphonate, and their phosphonic monoacid and diacid derivatives, N-acrylamidomethylphosphonic acid; vinylbenzylphosphonate dialkyl ester derivatives, the di(n-propyl), di(isopropyl), diethyl, dimethyl, di(2-butyl-3,3′-dimethyl) and di(t-butyl) ester derivatives, and their phosphonic monoacid and diacid alternative forms, vinylbenzylphosphonic diacid; diethyl 2-(4-vinylphenyl)ethanephosphonate; dialkylphosphonoalkyl acrylate and methacrylate derivatives, 2-(acryloyloxy)ethylphosphonic acid dimethyl ester and 2-(methyacryloyloxy)ethylphosphonic acid dimethyl ester, 2-(methacryloyloxy)methylphosphonic acid diethyl ester, 2-(methacryloyloxy)methylphosphonic acid dimethyl ester, 2-(methacryloyloxy)propylphosphonic acid dimethyl ester, 2-acryloyloxy)methylphosphonic acid diisopropyl ester or 2-(acryloyloxy)ethylphosphonic acid diethyl ester, and their phosphonic monoacid and diacid alternative forms, 2-(methacryloyloxy)ethylphosphonic acid, 2-(methacryloyloxy)methylphosphonic acid, 2-(methacryloyloxy)propylphosphonic acid, 2-(acryloyloxy)propylphosphonic acid and 2-acryloyloxy)ethylphosphonic acid; vinylphosphonic acid, optionally substituted by cyano, phenyl, ester or acetate groups, vinylidenephosphonic acid, in the form of a salt or the form of its isopropyl ester, or bis(2-chloroethyl)vinylphosphonate.

8. The method of claim 7, wherein monomer (A) is selected from the group consisting of acrylic acid, methacrylic acid, vinyl phosphonic acid, vinyl sulfonic acid, styrene sulfonic acid, and 2-acrylamido-2-methylpropane sulfonic acid, their salts or their precursors.

9. The method according to claim 1, wherein monomer (B) is selected from the group consisting of: styrene and styrene derivatives, α-methylstyrene, p-methylstyrene or p-(t-butyl)styrene; alkyl esters of acrylic or methacrylic acid, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate; C₃-C₁₂ vinyl nitriles, acrylonitrile or methacrylonitrile; vinyl or allyl esters of carboxylic acids, vinyl or allyl acetates, propionates, stearates; vinyl halides, vinylidene halides, or vinylaromatic halides, vinyl chloride, vinylidene chloride or pentafluorostyrene; α-olefins, ethylene; and conjugated diene monomers, butadiene, isoprene, chloroprene.

10. The method according to claim 1, wherein agent (R) complies with formula (I): 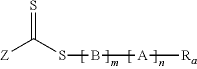
wherein:
Rₐ is selected from the group consisting of: —C(CH₃)₂—CH₂CH₂—CO₂H, —CH(CH₃)CO₂H, —CH(CO₂H)CH₂CO₂H, —C(CH₃)₂CO₂H, —CH₂(C₆H₅), —C(CN)(CH₃)CO₂H, —C(CN)(CH₃)CH₂CH₂CO₂H;
-[A]ₙ- represents a sequence of repeating units-A-derived from at least one monomer (A) selected from the group consisting of acrylic acid, methacrylic acid, vinyl phosphonic acid, vinyl sulfonic acid, styrene sulfonic acid, and 2-acrylamido-2-methylpropane sulfonic acid, their salts or their precursors, whereas n is an integer from 2 to 300;
-[B]ₘ- represents a sequence of recurring units -B- derived from at least one monomer (B) selected from the group consisting of alkyl esters of acrylic or methacrylic acids, whereas m is an integer from 2 to 300; and
Z is selected from the group consisting of optionally substituted alkylthio groups; and/or
wherein in agent (R), the molar ratio between units of the sequence -[A]ₙ- and units of the sequence -[B]ₘ- is between 0.6 and 1.4; and/or
wherein agent (R) is present in the aqueous medium under the form of dispersed particles having an average particle size Dz of less than 100 nm.

11. The method according to claim 1, wherein the monomer (F) is selected from the group consisting of:
C₂-C₈ perfluoroolefins;
C₂-C₈ hydrogen-containing fluoroolefins;
(per)fluoroalkylethylenes complying with formula CH₂═CH—R_{f0}, in which R_{f0} is a C₁-C₆ (per)fluoroalkyl or a C₁-C₆ (per)fluorooxyalkyl having one or more ether groups;
chloro- and/or bromo- and/or iodo-C₂-C₆ fluoroolefins;
fluoroalkylvinylethers complying with formula CF₂═CFOR_{f1} in which R_{f1} is a C₁-C₆ fluoro- or perfluoroalkyl;
hydrofluoroalkylvinylethers complying with formula CH₂═CFOR_{f1} in which R_{f1} is a C₁-C₆ fluoro- or perfluoroalkyl;
fluoro-oxyalkylvinylethers complying with formula CF₂═CFOX₀, in which X₀ is a C₁-C₁₂ oxyalkyl, or a C₁-C₁₂ (per)fluorooxyalkyl having one or more ether groups;
functional fluoro-alkylvinylethers complying with formula CF₂═CFOY₀, in which Y₀ is a C₁-C₁₂ alkyl or (per)fluoroalkyl, or a C₁-C₁₂ oxyalkyl or a C₁-C₁₂ (per)fluorooxyalkyl, said Y₀ group comprising a carboxylic or sulfonic acid group, in its acid, acid halide or salt form;
fluorodioxoles, of formula: 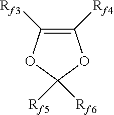
wherein each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom.

12. The method according to claim 11, wherein the mixture (M) is selected from the group consisting of:
(1) vinylidene fluoride (VDF) containing monomers mixtures, mixtures (M_{VDF}), in which VDF is mixed with at least one comonomer different from VDF and selected from the group consisting of:
(a) C₂-C₈ perfluoroolefins;
(b) hydrogen-containing C₂-C₈ fluoro-olefins;
(c) C₂-C₈ chloro and/or bromo and/or iodo-fluoroolefins;
(d) (per)fluoroalkylvinylethers (PAVE) of formula CF₂═CFOR_{f}, wherein R_{f} is a C₁-C₆ (per)fluoroalkyl group;
(e) (per)fluoro-oxy-alkylvinylethers of formula CF₂═CFOX, wherein X is a C₁-C₁₂ ((per)fluoro)-oxyalkyl comprising catenary oxygen atoms;
(f) (per)fluorodioxoles having formula: 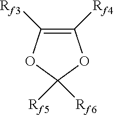
wherein R_{f3}, R_{f4}, R_{f5}, R_{f6}, equal or different from each other, are independently selected among fluorine atoms and C₁-C₆ (per)fluoroalkyl groups, optionally comprising one or more than one oxygen atom;
(g) (per)fluoro-methoxy-vinylethers (MOVE) having formula:
CFX₂═CX₂OCF₂OR″_{f}
wherein R″_{f} is selected from the group consisting of C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂═F, H;
(h) C₂-C₈ non-fluorinated olefins (Ol); and
(2) tetrafluoroethylene (TFE) containing monomers mixtures [mixtures (M_{TFE})], mixtures (M_{TFE}), in which TFE is mixed with at least one comonomer different from TFE and selected from the group consisting of monomers of classes (a), (c), (d), (e), (f), (g), and the following:
(i) perfluorovinyl ethers containing at least one nitrile group.

13. The method according to claim 12, wherein the mixture (M) is selected from the group consisting of the following mixtures (M) (in mol %):
(j) vinylidene fluoride (VDF) 35-85%, hexafluoropropene (HFP) 10-45%, tetrafluoroethylene (TFE) 0-30%, (per)fluoroalkyl vinyl ethers (PAVE) 0-15%, bis-olefin (OF) 0-5%;
(ii) vinylidene fluoride (VDF) 50-80%, (per)fluoroalkyl vinyl ethers (PAVE) 5-50%, tetrafluoroethylene (TFE) 0-20%, bis-olefin (OF) 0-5%;
(iii) vinylidene fluoride (VDF) 20-30%, C2-C8 non-fluorinated olefins (Ol) 10-30%, hexafluoropropene (HFP) and/or (per)fluoroalkyl vinyl ethers (PAVE) 18-27%, tetrafluoroethylene (TFE) 10-30%, bis-olefin (OF) 0-5%;
(iv) tetrafluoroethylene (TFE) 50-80%, (per)fluoroalkyl vinyl ethers (PAVE) 20-50%, bis-olefin (OF) 0-5%;
(v) tetrafluoroethylene (TFE) 45-65%, C2-C8 non-fluorinated olefins (Ol) 20-55%, vinylidene fluoride (VDF) 0-30%, bis-olefin (OF) 0-5%;
(vi) tetrafluoroethylene (TFE) 32-60% mol %, C2-C8 non-fluorinated olefins (Ol) 10-40%, (per)fluoroalkyl vinyl ethers (PAVE) 20-40%, fluorovinyl ethers (MOVE) 0-30%, bis-olefin (OF) 0-5%;
(vii) tetrafluoroethylene (TFE) 33-75%, (per)fluoroalkyl vinyl ethers (PAVE) 15-45%, vinylidene fluoride (VDF) 5-30%, hexafluoropropene HFP 0-30%, bis-olefin (OF) 0-5%;
(viii) vinylidene fluoride (VDF) 35-85%, (per)fluoro-methoxy-vinylether (MOVE) 5-40%, (per)fluoroalkyl vinyl ethers (PAVE) 0-30%, tetrafluoroethylene (TFE) 0-40%, hexafluoropropene (HFP) 0-30%, bis-olefin (OF) 0-5%;
(ix) tetrafluoroethylene (TFE) 20-70%, (per)fluoro-methoxy-vinylether (MOVE) 30-80%, (per)fluoroalkyl vinyl ethers (PAVE) 0-50%, bis-olefin (OF) 0-5%,
In which the expression bis-olefin (OF) designates a bis-olefin having general formula: 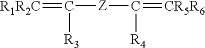
wherein R₁, R₂, R₃, R₄, R₅ and R₆, equal or different from each other, are H, a halogen, or a C₁-C₅ optionally halogenated group, optionally comprising one or more oxygen group; Z is a linear or branched C₁-C₁₈ optionally halogenated alkylene or cycloalkylene radical, optionally containing oxygen atoms, or a (per)fluoropolyoxyalkylene radical.

14. The method according to claim 1, wherein the aqueous medium comprises at least one iodinated and/or brominated chain-transfer agent(s).

15. The method according to claim 1, wherein polymer (F) is a fluoroelastomer.

16. A latex obtained from the method according to claim 1.

17. The method according to claim 1, wherein the aqueous medium comprises at least one iodinated and/or brominated chain-transfer agent(s) selected from the group consisting of those of formula Rf(I)x(Br)y, in which Rf is a (per)fluoroalkyl or a (per)fluorochloroalkyl containing from 1 to 8 carbon atoms, while x and y are integers between 0 and 2, with 1≤x+y≤2.
